(19) United States
(12) Patent Application Publication
(10) Pub. No.: US 2012/0090488 A1
(43) Pub. Date: Apr. 19, 2012

(54) METHODS AND SYSTEMS FOR MULTICOLOR PROCESS PRINTING EMPLOYING BOTH PROCESS COLORS AND SPOT COLORS IN THE PROCESS INK SET

(75) Inventors: Stephen R. Postle, Glen Rock, NJ (US); Danny C. Rich, Hamilton Square, NJ (US); Andrew Hadaway, Kent (GB)

(73) Assignee: Sun Chemical Corporation, Parsippany, NJ (US)

(21) Appl. No.: 13/266,717

(22) PCT Filed: Apr. 28, 2010
(86) PCT No.: PCT/US10/01266

§ 371 Date: Dec. 9, 2011

Related U.S. Application Data
(60) Provisional application No. 61/173,280, filed on Apr. 28, 2009.

(51) Int. Cl. B41F 33/00

(52) U.S. Cl. 101/483

(57) ABSTRACT

Spot colors reproduce high value brand colors to supplement conventional process colors for printed images and packaging A printing press can utilize hi-fidelity process inks with at least three unique colors and black, and spot colors for printing solid brand colors and for printing over other colors to produce wide-gamut, half-toned color reproductions printing logos on a substrate includes (i) printing the spot colors using spot inks, and (u) printing the remainder of the image using a substituted original process ink set. Such method can alternatively include (in) reading the spectral characteristic of the inks, (iv) determining if any color in the image is identified by a color management method from the default process ink set palette, (v) processing the out-of-palette-colors using spot colors and the standard process ink set, and (vi) applying a tone scale value increase (TVI) to the process color sets

### CROSS REFERENCE TO OTHER APPLICATIONS:

This application claims the benefit of U.S. Provisional Patent Application No. 61/173,280, filed on Apr. 28, 2009.

### TECHNICAL FIELD

The present invention relates to multicolor process printing technology, and in particular to methods and systems for multicolor printing using both process colors and spot colors.

### BACKGROUND OF THE INVENTION

The term “house colors” “spot colors” or “brand colors” refers to customer-specific multi-pigmented colors that are often associated with a specific product or brand name, such as, for example, the well known precise hues of red and yellow used by Kodak® in its packaging and advertising. Accordingly, brand colors are sometimes referred to as “special colors.”

A spot color ink is a custom blended ink that has been formulated to match the brand owner's design concept or brand color. These brand colors are often trademark colors and to maintain the force of the trademark, the color must be kept within a tight tolerance of the original aim. While a hi-fi process printing set can often match the brand color, the process of halftone printing is a stochastic event and the normal variations in process printing can produce variances in the final printed color that render the brand color outside of the trademark tolerance.

Conventional multicolor ink sets do not possess the advantage of house color vividness. This is due to the fact that in conventional process printing, every color is made up of overlapping process ink dots. Given the variability in dot location inherent in the multicolor printing process (whether flexo, sheet-fed offset, digital or other print processes) a house color printed using these standard process tends to be less sharp and less vivid.

The following references describe various conventional techniques and their defects:

U.S. Pat. No. 5,689,349, Method and a device for generating printing data in a color space defined for non-standard printing inks, describes how Pantone PMS® color can be substituted for one of the four standard process colors (CMYK) but dislcoses nothing regarding combining spot colors and process colors.

U.S. Pat. No. 5,734,800, Six color process system teaches that the gamut of four standard process colors (CMYK) can be expanded by adding two additional process colors (OG).

U.S. Pat. No. 5,751,326 Color Printing Process and Product, describes a method for converting a scanned image in RGB space into a set of printing formes for a process ink set comprised of CMYKRGB inks. However, no mention is made as to how to convert an extended gamut process set into a spot color, or how to incorporate a spot color into an extended gamut process set. The process primaries are defined by reference to specific Pantone® PMS® color swatches.

U.S. Pat. No. 5,812,694, Color Separation Method And Apparatus For Same, describes a colorant selection algorithm for a color reproduction device. The algorithm looks at a range of primary colors and selects all reasonable subsets of those primaries to yield the most stable match to a given spot or line color, a step used in producing the printing formes required to reproduce a spot color using a process set. However, once again, there is no discussion as to how to use a spot color as a substitute or extension to a given process color set.

U.S. Pat. No. 5,870,530 System for Printing Color Images with Extra Colorants in Addition to Primary Colorants, describes the use of a secondary set of process primaries in an extended gamut 7 color process set to enhance the gamut of the CMYK ink primaries by overprinting with the extra process ink set. The system is used to create printing formes that “fill” in the process regions of color space between the C and Y with overprints of the G process primary. It does not teach how to match spot colors with process colors or how to incorporate a spot color into the extended gamut process ink set. The printing forme is a virtual forme as the preferred embodiments are for digital electrophotographic printing devices.

U.S. Pat. No. 5,892,891 System for Printing Color Images with Extra Colorants in Addition to Primary Colorants, is a continuation of U.S. Pat. No. 5,870,530 in which an exact algorithm for six or seven color process printing is described. Additionally, this patent describes how to reduce the number of process primaries from six or seven to multiple subsets of four inks so that traditional color separation techniques may be applied to creating the printing forme. This invention does not describe using spot colors in the process set.

U.S. Pat. No. 6,307,645 Halftoning for Hi-Fi Color Inks, is a continuation of U.S. Pat. No. 5,870,530 in which a method for creating halftone screens for a six or seven color process set is described. The invention teaches how to print more than four primary inks without the need for additional halftone screening requirements by assigning one or more the screening properties of the CMYK ink set to the extra inks when used in combinations four inks at a time. Again, this does not describe spot colors or substituting spot colors into the process set. The described method suffers from the restriction that it is based on the use of virtual printing formes, as used in digital electrophotographic printing, where screen properties can be changed via digital computer codes. In a traditional packaging printing application using offset, flexographic or gravure printing technology, the printing forme is fixed for all print regions. Thus, for example, the O ink may use the M screen in one area of the image being printed and the C screen in a different area of the same image. While this is achievable in digital printing, it is simply not possible in conventional printing.

U.S. Pat. No. 6,637,851 Color Halftoning for Printing with Multiple Inks, describes another form of color separation algorithm using digital image data in place of the traditional continuous tone image data. The described technique relates to taking the process ink sets in pairs and statistically distributing the color over a predetermined area of the image, in a process known as super pixilation or dithering. This is a process used in traditional packaging known as FM screening and has been incorporated in trademarked processes such as, for example, FMsix®.

US 2004/0114162 and EP 1364524 Method for Printing a Colour Image, describe the FMsix printing process in which spot colors are matched with a hi-fi process set in which (i) the photographic image data are printed using traditional CMYK halftoning and (ii) logos and brand colors are printed using the extended gamut printing set and digital frequency modulation halftoning. The method is said to reproduce with an accuracy of 6 CIELAB color difference units 85% of all known spot colors. It does not teach the use of spot colors as the secondary set of extended gamut colors.

U.S. Pat. No. 7,123,380 Method and a Device for Determining Multi-ink Color Separations, describes the conversion of a color in an image defined in a 3 or 4 dimension color space (RGB or CMYK) into a color space defined by more than 4 dimensions or colorants. This is a color separation process that is based on mapping the gamut of colors of one color space into or onto the gamut of colors of the second and third color spaces. This approach is used to take a traditional CMYK image and move it to a digital proofing device that uses more than 4 primary colors to obtain a larger gamut for proofing. The described method does not discuss matching spot colors or using spot colors as the extended gamut colors.

U.S. Pat. No. 7,164,498 Color Matching for a Printing Process Using More than Four Colorants Using a Four-Colorant Color Management System, describes taking an RGB image and mapping it onto multiple output devices utilizing a variation of the ICC profile method. It is primarily a method for digital color separation involving a “Virtual CMYK” profile. This concept defines a printing system with an ideal, unattainable CMYK color gamut which is larger than either of the real CMYKOG or CMYKRGB extended gamuts. Then gamut compression is used to map the unreal CMYK onto the real extended gamut process primary set. No description is provided regarding spot colors or using spot colors in the process set.

U.S. Pat. No. 7,199,903, Method and Device for Determining the Color Appearance of Color Overprints, describes a method for numerical prediction of the color and appearance of a series of overprinted process primaries. This teaching applies to creating a printing forme that produces a combination of a range of process inks that will reproduce a desired color on a printing device. The teaching does not disclose or identify the matching of spot colors or the use of spot colors in the process set, though the techniques disclosed here could be useful in providing the definition of the print formes required to do so.

Thus, according to prior art techniques, there is no facility for using spot or line colors as process primaries. Rather, the prior art methods seek to use extended gamut primaries such as OG, VG, RGB, OGV, etc. which are found in many digital proofing printers, such as, for example, the HP z3100®, Canon iPF5000® or Epson Stylus Pro 7900®.

In fact, rather than contemplating using spot colors in the process set, conventional approaches replace the spot colors with a process set containing more than 4 colorants so as to hopefully have a large enough gamut to reproduce a given spot color (or set of colors) using overprinted process primary colors. As described above, this process has been shown in commercial applications to have significant shortcomings and limitations,

What is needed is a method of multicolor process printing that solves the aforementioned problems of the prior art as relates to spot color printing.

### BRIEF DESCRIPTION OF THE DRAWINGS

FIG. 1 is a CIELAB diagram illustrating the relationship between an additive process set and an exemplary spot orange color; and

FIG. 2 is a CIELAB diagram illustrating increasing the gamut of colors available from a CMYK process set and three exemplary spot colors according to an exemplary embodiment of the present invention.

### SUMMARY OF THE INVENTION

Methods and systems for producing printed images and packaging containing both process colors and spot colors are presented. In exemplary embodiments of the present invention, spot colors can be used to reproduce high value brand colors as well as to supplement and extend the gamut of the process colors. In exemplary embodiments of the present invention a printing press can utilize a set of hi-fidelity process inks with at least three unique colors and black and at least one spot color which can be utilized for both printing solid brand colors and for printing with and over the process colors to produce wide-gamut, half toned color reproductions.

### DETAILED DESCRIPTION OF THE INVENTION

Spot Colors

In exemplary embodiments of the present invention, house colors (also known as “brand”, “line” or “spot” colors) can be produced with the same vividness as when printing spot colors as solids, because the house color is substantially printed as such, rather than being made up of overlapping process ink dots. Given the variability in dot location inherent in the multicolor printing process (whether using, for example, flexo, sheet-fed offset, digital or other print processes), a sharper, more vivid and unsaturated dot of a house color will result using the methods according to exemplary embodiments of the present invention than when using a conventional four, six, or even seven, color process set.

Moreover, by employing a spot color as a part of a multicolor process printing set, gamut extensions over purely process color ink sets can be obtained. An additional benefit is that excess stock of a particular spot color can be “worked away” as a part of a process set, thus reducing working capital requirements for running a printing business.

In conventionally known methods of printing packages and advertisements that require the reproduction of a house, trademark or brand color, printers have historically used custom blended ink to produce these colors. The ink blends may, for example, be supplied by an ink maker or, for example, they may be referenced from a formula guide, such as, for example, the Pantone Matching System®. Such a custom blended ink is known as in the printing trades as a line or spot color.

The pre-press function in the printing workflow creates a printing forme for the transfer of the ink to job substrate. Historically, this transfer process has been without halftone structures but is printed as a solid color. More recently, it has become popular to use the spot color in a vignette that fades from a solid down to the substrate color. Making such a vignette requires halftoning of the spot color ink. Printing an ink as a solid region or as single ink vignette is a relatively simple process, and thus in doing this a printer can be confident that a consistent color will be produced.

Process Printing

On the other hand, process printing involves printing of complex patterns of small dots of ink of varying colors. The minimal number of inks required for a process set is three. In such a process ink set, the three inks are identified as CMY, which stands for cyan, magenta and yellow. A very large number of colors can be reproduced by the combination of these three inks as dotted areas or tones. A pale or pastel area will have small dots and a strong or dark area will have large dots. Additionally, overprinting of the inks results in a range of new hues.

Thus, for example, if a yellow (Y) ink is printed over a magenta (M) ink, the overprint color will be bright red and the hue of the red can shift from bluish to yellowish as more or less of the yellow is printed. Similarly, cyan and yellow can be overprinted to produce a range of green colors, and cyan and magenta can be overprinted to produce a range of blue colors.

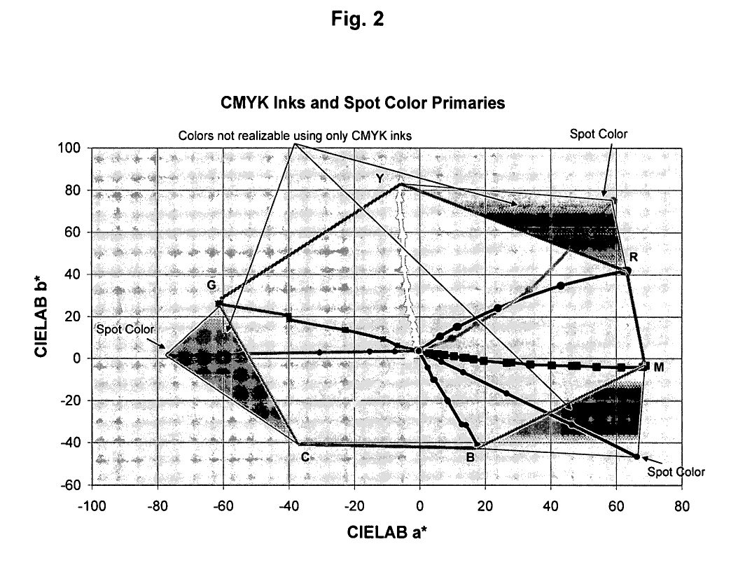

However, the range of intermediate colors that can be achieved in this manner is limited due to the transfer of one ink over or onto the other ink. Thus, for example, certain bright hues, light colors or dark colors may not be achievable—and are thus said to be “out of the gamut” of the CMY process ink set. One way to increase the range of dark colors is to add a black ink (K) to the process set. Another way is to add secondary hues to the process ink set, such as orange, yellow-green or violet, so as to expand the gamut of colors that may be produced relative to using only two of the standard hues (CMY). Thus, for example, one might print a magenta ink and an orange ink (M+O) to produce a range of colors from orange-red to blue-red. Or, for example, one might also print a green ink with a cyan ink (G+C) to produce a range of colors from olive green to turquoise. This is described in connection with FIG. 2, below.

It is noted that process printing of one ink tone over another ink tone has an inherent variability that can often result in the degradation of the accuracy and reproducibility of printing. For example, while spot color inks can be printed with a tolerance of less than 3 CIELAB color difference units, the best hi-fi process printing techniques report a reproducibility of only 6 CIELAB color difference units. Because complex images containing natural or synthetic scenes tend to contain a large amount of visual noise (small image elements with varying colors), the perception of small color differences is improbable. Thus, it is more reasonable and efficient to replace the process primaries with spot colors, resulting in a less than optimum process set than to replace the spot colors with process printing, and result in less than optimal printing of crucial (form a branding and marketing perspective) spot colors.

Many printing presses are now set up with six, eight or even more print stations. Presses of this size, for example, have been used to print packages with a large number of house or brand colors (often as a solid, or a vignette as described above). Such brand colors use inks that are custom formulated to achieve very exactly the desired brand color, thus maintaining the high-value of the brand. But the use of such dedicated print stations (i.e., to a specific spot color) presents a given printer with a low efficiency system, inasmuch as between each job all inking stations must be dismantled, thoroughly cleaned and reassembled before the next job can be queued (as the next job will not utilize the specific spot colors).

Increasingly, for just these reasons of productivity and obtainable gamut, printers are employing a matched set of more than four (4) process inks and using this process set to render printed images, whereas formerly a special house or spot color would be printed. Such 5, 6, or 7 ink process sets can (i) reduce down time by keeping the same inks in their respective print stations, (ii) provide the ability to print multiple images of differing types across a web and (iii) reduce the quantities and types of inks required to be maintained in a print shop.

However, despite the gains in productivity, it is not always possible to obtain the equivalent color or saturation of the house or spot color due to color gamut limitations or ink transfer restrictions of even such an expanded process ink set. As noted, this can be an egregious problem inasmuch as the house or spot color is often the most important element of a print design to a brand owner.

Multicolor Printing Using Both Process Colors and Spot Colors

In exemplary embodiments of the present invention, by employing a multicolor ink set that combines both the usual process colors or a hi-fi process color set (such as, for example, CMY, CMYK, CMYKOG, or CMYKRBG) and one or more house or spot colors on the same press, (i) all advantages of the technique of multicolor process printing can be preserved, with the additional benefit that (ii) the quality of the printed house color can now be enhanced considerably over that obtained by a conventional process set. In exemplary embodiments of the present invention a further benefit can also be realized: the ability to extend the gamut of the multicolor ink set over that of a comparable process ink set by using one or more of the house colors as a member of the process set, thus permitting more eye-catching print and designs to be produced.

For example, assume a given snack food has a cheddar cheese flavor and the brand is made attractive by using a bright orange spot color in the trademarked name “CHEESE SNACK”. The lettering has a drop shadow that is made from the same orange spot color mixed with a small amount of brown ink to darken the orange ink while keeping the hue similar. However, if one use a process color set to match the orange, then the over print of yellow and magenta may or may not be able to produce the exact hue of the orange, due to the trapping of the second down ink over the first down ink. The intermediate or secondary color printed by the full overprints will be a red ink and the transition from red to yellow passes through some set of oranges but rarely the exact orange required.

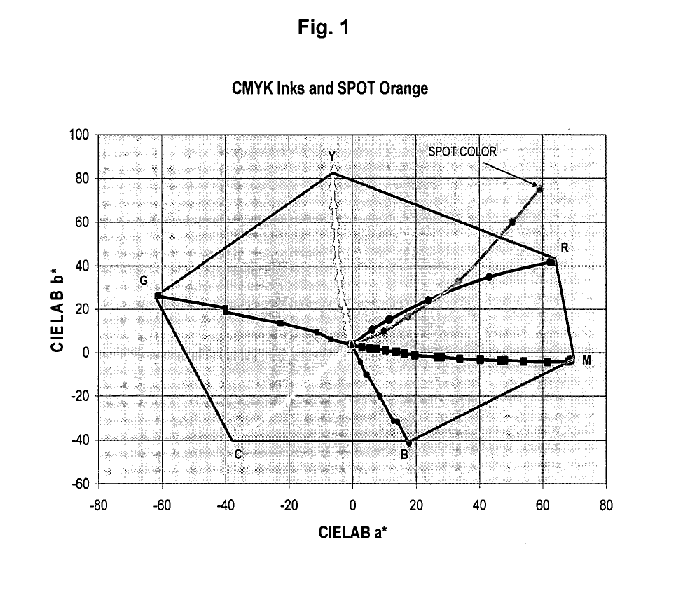

This is generally illustrated in FIG. 1, which depicts how the additive process set produces linear area of colors from the overprinted mixing of two sets of ink dots. With reference thereto, there is shown a spot color which is an orange, the process colors C, M and Y, and secondary colors Red, Green and Blue. The spot orange color is close to, but does not overlap (except at a point) the Red color line. Thus, precisely reproducing the specified spot orange color is difficult.

As noted above, printing a combination of a four color process ink set (CMYK) and one or more spot color inks (used to print the brand colors) is well known. However, a better solution is to print brand colors with the custom blended spot color ink and then print the rest of the graphic image using a hi-fi process ink set. To regain the full flexibility of the hi-fi printing system, in that multiple brand images can be printed across the web, the press would need one or more additional print stations for each brand color ink required plus the 6 to 8 print stations required for the hi-fi process inks. This can obviously result in a situation that is untenable for most print shops given the excessive cost and complexity of such a press.

Extension of Gamut of Process Ink Sets

In exemplary embodiments of the present invention this dilemma can be solved by substituting one or more of the spot color inks for its respective equivalent member of the hi-fi process ink set. For example, a hi-fi ink set may contain a CMYKOG set, where C is a cyan ink, M is a magenta ink, Y is a yellow ink, K is a black ink, O is an orange ink and G is a green ink, and the graphic design may include a Red brand color as well as an Orange brand color. Instead of overprinting YM to create the brand (spot) Red and YMO to create the brand (spot) Orange, the spot color Red can be substituted for the M process ink and the special spot color Orange for the O process ink. In order to accommodate this substitution, the process printed areas of the image can be rebalanced—adding, for example, some C into the Red print to produce a match to the original M process ink and some Y or M into the Orange print to produce a match to the original O process ink. Since, as noted, the process printed colors have more latitude in their tolerances the overprinted halftoned inks using the brand Red and Orange as part of the process set will produce fully acceptable images.

Producing a predictable image coloration from a set of process primary inks requires a characterization of the printing system. Such a characterization can be, for example, in the form of adherence to an ISO 12647 printing condition with associated color aims and tone scale values for a CMYK ink set, or, for example, it can conform to a hi-fi ink set as described in either U.S. Pat. No. 5,734,800 or in U.S. Pat. No. 5,870,530. Or, for example, it can use a scanning process as described in U.S. Pat. No. 5,751,326, or for example, it can utilize a special algorithm for creating the separations and printing formes such as is described in EP 1354524 where a combination of AM and FM screening techniques are utilized. Alternatively, for example, such a characterization can be performed by following the industry press calibration specifications known as “G7” as promoted by US printing industry consortium IDEAlliance and adopted by specifications like SWOP and GRACoL, or, for example, by generating a profile of the press ink color space to perceptual color space as defined by the International Color Consortium (ICC). As described in U.S. Pat. No. 5,812,694, a primary consideration should be the selection and stability of the overprints when attempting to match spot colors using process color inks.

Thus, to successfully back-utilize a spot color as an enhanced gamut process primary, it is necessary to compute or look up the color created by all possible combinations of two ink overprints. In process printing this also requires the knowledge of the tone scale value increase (TVI) which changes as a function of the substrate color and surface character (matte, gloss, coated, uncoated). Traditional attempts at matching spot colors with process color sets, utilize either a brute force interpolation scheme, such as available in the ICC B2A transform or via some form of Neugebauer model as described in Rolleston and Balasubramanian, “Accuracy of Various Types of Neugebauer Model”, Proceedings of the Second IS&T/SID Color Imaging Conference, pp 625-630, (1993). In this study, models based on spectral properties always out performed all other models. Similarly, the spectral model is recommended in Wyble and Berns, “A Critical Review of Spectral Models Applied to Binary Color Printing”, Color Research and Application, vol 25, no 1, 4-19, (2000). In exemplary embodiments of the present invention, this model can be applied to any process set and required (spot) colors in an image.

In exemplary preferred embodiments, the spectral characteristic of all inks can, for example, be read using a spectrophotometer, preferably with a geometry conforming to ISO 13655 which specifies 45 degree influx and 0 degree efflux angles. Any color in an image that is identified by the ICC color management method (CMM) as being out of the gamut of the default CMYK process set can be processed using one or two spot colors in addition to the standard process set and applying the TVI of the process set, available from the ICC profile. The required tone level of each ink will be obtained by nonlinear optimization of the spectral Neugebauer equations for those primaries. The minimization criteria will be a metamerism index or simultaneous color matching for two or three illuminants. Such an approach to obtain a maximally stable and minimally metameric color match is found in E. Allen, “Basic equations used in computer color matching, II. Tristimulus match, two-constant theory”, Journal of the Optical Society of America, Vol. 64, Issue 7, pp. 991-993, (1974).

Thus, in exemplary embodiments of the present invention, the known printing characteristics of the standard process set can be used, and additionally hi-fi color overprints can be computed using the spectral characteristics of the spot colors. The spectral Neugebauer and computer assisted color-matching algorithms are well known to those skilled in the art, but, as shown above, the application of these well known methods to predicting extended gamut hi-fi process color matches and the equivalent spot colors has not been described.

In exemplary embodiments of the present invention the described color matching method can, for example, also automatically provide color separation data for preparing printing formes from the digital data. For example, known separation algorithms operate on computing the RGB to CMYK or CMYKOGV, CMYKRGB, Hexachrome or Opaltone methods. For example, most HiFi ink sets are provided with a separation algorithm.

FIG. 2 depicts how the addition of three spot colors to a standard CNYK process set increases the gamut of colors available from that set. With reference thereto, there is seen, in addition to the CMY inks, three additional spot colors—the Orange of FIG. 1, as well as a spot color approximately midway between Cyan and Green, and a third spot color essentially midway between Magenta and Blue. Using the now available six primary colors, additional hues can now be achieved. There is thus seen a triangular area that culminates in an approximately right angle at the end of each of the additional three spot color lines. Within these three triangles are the additional hues that can be achieved using the respective three additional spot colors.

Thus, in exemplary embodiments of the present invention, one or more spot colors can be added to primary process set to not only print the spot colors without overprinting, but to also additionally increase the available hues from the {primary+additional spot colors} process set.

In preferred exemplary embodiments of the present invention, the whole image can be printed utilizing FM screening. In alternate exemplary embodiments AM screening can be used as well. It is noted in this regard that AM screens have patterns of parallel lines that require angular orientation to prevent moire effects due to almost periodic mismatches. Thus each plate must be created with its screen at a specific angle. This prevents full overlap of halftone dots and creates a hexagonal packing known as the printers rosette. FM screens are stochastic and hence, random—and thus they are not subject to moiré. As a result, all parts of the image can be printed with this technology, which is similar to color image printing on a digital (inkjet or electro-photographic engine) printer. Alternatively, in exemplary embodiments of the present invention, one can choose to print all image parts in AM or in FM or in a combination of AM and FM screening.

In exemplary embodiments of the present invention, a stable printing system, using well known and behaved printing processes to those skilled in packaging or advertising printing, can be provided, where special spot or brand colors must be printed as solids for logos and brand names and in tone scales for vignettes and to provide high fidelity color images. In such exemplary embodiments changes in a given print job will only require changing those print stations that have different spot colors contained in the next print job.

Thus, in exemplary embodiments of the present invention, a job that prints using CMYK+S1, S2, S3 (where the latter three colors are spot colors) will complete as intended and a next job that requires CMYK+S1, S2, S4 will need to have only the last inking station cleaned and setup prior to beginning printing. Because the print stations for, for example, S1, S2 and S3 have unique print formes, the inks can be combined with the CMYK, as predicted by a spectral color matching method and two color overprints of, for example, S1+{C or M}, S2 with {M or Y}, or S3 with {C or Y} can be used to achieve an extensive gamut increase while still maintaining the high quality and color fidelity of the brand colors and logos in the images.

It is noted that an issue in converting a spot color to process color is transparency. Generally, brand color inks are not tested as critically for transparency since they are not used in a process set. Process inks must be very transparent to show the color underneath to form the 2-color overprint. Thus, in exemplary embodiments of the present invention, where a spot color is used as part of a process set, the spot color ink can be made to be sufficiently transparent so as to facilitate its use for overprinting.

Additionally, registration plays a role. An ideal press would place one dot exactly over the previous dot. However, that generally cannot happen as screens are rotated, and thus the position of a 2^{nd} ink is not exactly over the top of a first ink. On the other hand, it is a much easier process to print small dots of very vivid spot colors on an unprinted substrate to obtain a pastel color of the same hue as the spot color or to print over a larger black or complementary color to get a dark or muddy color. It is noted that in exemplary embodiments of the present invention to print two colors one over the other at full tone to attempt to get the most vivid 2-color overprint possible can be difficult and needs to be carefully done.

Choosing a Process Ink Set Given a Set of Spot Colors

CMYK is defined by international standards (ISO 12647 parts 1 to 7; parts 8 and 9 are still being developed). These standard documents cover web heatset, sheetfed, coldset, gravure, screen, flexo, contract proofing, validation proofing and wide format digital printing. Those CMY inks were chosen to split the hue circle evenly, i.e., Y at 90 deg, C at 225 deg, and M at 315 deg. However, pigments for inks are not always available at some of those angles so compromise is inevitable. Thus, M is generally closer to 360 deg.

Thus, in exemplary embodiments of the present invention the goal in selecting an appropriate process ink set can be, for example, to obtain a reasonable gray balance (C+M+Y=neutral). Thus, prepress software can be used, for example, to adjust the ratio of the inks to maintain such balance. Adding a 5th, 6th or 7th process primary ink gains some additional reproduction colors, as shown above in FIG. 2. In this regard it is noted that there are various known techniques for crafting HiFi color sets using {Orange+Blue} or {Red+Green+Blue} or {Orange+Green+Violet} in addition to CMYK, all of which attempt to split the difference between the existing primaries of {Cyan+Magenta+Yellow} as most appropriate for a given set of desired hues. However, if the spot color is not Orange or Green or Violet, in exemplary embodiments of the present invention the prepress software must be recalibrated and color and tone properties of both the spot color and the process color inks captured in a reproduction table or ICC profile. In exemplary embodiments of the present invention software for capturing this color behavior for typical HiFi ink sets can be utilized to provide digital files capable of producing offset or flexo plates or engraving a gravure cylinder.

Thus, for example, if one needs to print some spot colors, such as, for example, the well known Kodak® Red and Yellow spot colors, and also wants to print some images, in exemplary embodiments of the present invention a hybrid process can be used to choose an appropriate process set. Initially the spot color inks can be created, and then one can look to see if the process inks can be shifted in a consistent way to maintain gray balance, which can then be performed using well known techniques.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A method of producing a printed image on a substrate or article, using N total colors, including m process colors and n spot colors, wherein N>2, m>2 and n>0, wherein N, m and n are integers.

2. The method of claim 1, wherein the n spot colors are blended with the m process colors to produce the printed image.

3-10. (canceled)

11. A method of producing a printed image on a substrate or article, comprising:
specifying a process ink set to be used;
specifying m spot colors to be used, where m is an integer greater than zero; for each of the m spot colors, replacing its respective equivalent member of the process ink set with the spot color to create a substituted color set;
computing color overprints for the image using the spectral characteristics of the substituted color set; and
printing the image using the computed color overprints.

12-14. (canceled)

15. The method of producing a printed image on a substrate or article of claim 11, further comprising: replacing the respective equivalent member of the process ink set with the spot color to create a substituted color set,
wherein the step of specifying a process ink set to be used includes a process ink set having members relatively closest to the m spot colors; for each of the m spot colors.

16-17. (canceled)

18. The method of any of claim 15, wherein said specifying the process ink set includes verifying that the process ink set can be shifted so as to maintain consistent gray balance.

19. A method of printing an image containing spot colors on a substrate, comprising:
printing the spot colors using one or more spot inks; and
printing the remainder of the image using a substituted process ink set created from an original process ink set, wherein the substituted process ink set comprises the one or more spot inks.

20. The method of claim 19, wherein the substituted process ink set has the one or more spot inks respectively substituted for their equivalent members of the original process ink set.

21. The method of claim 19, wherein the original process ink set is one of CMY, CMYK, CMYKOG, and CMYKRBG.

22. The method of claim 19, wherein the printing characteristics of the standard process set are used, and hi-fidelity color overprints are computed using the spectral characteristics of the spot colors.

23. The method of claim 19, further comprising:
reading the spectral characteristic of all inks;
determining if any color in the image is identified by a color management method as being out of the gamut of the default process ink set; and
processing said out of gamut colors using one or two spot colors in addition to the standard process set and applying a tone scale value increase of the process set.

24. The method of claim 23, wherein said reading the spectral characteristics of all inks is performed by a spectrophotometer.

25. The method of claim 24, wherein the spectrophotometer has a geometry having 45 degree influx and 0 degree efflux angles.

26. The method of claim 25, wherein the required tone level of each ink is obtained by nonlinear optimization of the spectral Neugebauer equations for those primaries.

27. The method of claim 26, wherein a minimization criteria is either a metamerism index or a simultaneous color matching for two or three illuminants.

28-32. (canceled)
